(19) United States
(12) Patent Application Publication
(10) Pub. No.: US 2005/0207908 A1
(43) Pub. Date: Sep. 22, 2005

(54) Radial piston pump for fuel injection system having improved high-pressure resistance

(76) Inventors: Paul Wuetherich, Schwieberdingen (DE); Josef Guentert, Gerlingen (DE); Karl-Heinz Linek, Remseck (DE); Florian Kleer, Merchweiler (DE); Gert Loesch, Filderstadt-Sielmingen (DE); Peter Grabert, Hoechen (DE); Nicola Cimaglia, Putignano (IT); Antonio Diaferia, Corato Bari (IT); Rosanna Iorizzo, Molfetta (BA) (IT); Sandra Ranaldo, Bologna (IT); Giuseppe Palma, Bergaro (IT)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/513,993

(22) PCT Filed: May 13, 2003
(86) PCT No.: PCT/DE03/01541

§ 371 Date: May 25, 2005

(30) Foreign Application Priority Data
May 14, 2002 (DE) 102213054

(51) Int. Cl. F04B 1/26

(52) U.S. Cl. 417/270

(57) ABSTRACT

A radial piston pump has a pump housing containing pump elements and whose high-pressure conduits extending in the pump housing are embodied so as to significantly increase the permissible operating pressures.

### PRIOR ART

The invention relates to a radial piston pump for high-pressure fuel delivery in fuel injection systems of internal combustion engines, particularly in a common rail injection system, preferably with a number of pump elements arranged radially in relation to a drive shaft supported in a pump housing, the pump elements being actuated by the drive shaft and each having a respective inlet side and high-pressure side, and with high-pressure conduits in the pump housing, each of which connects the high-pressure side of a respective pump element to a high-pressure connection in the pump housing.

A radial piston pump of this kind is known, for example, from DE 197 29 788.9 A1. This mass-produced radial piston pump achieves operating pressures of up to 1300 bar on the high-pressure side. These result in considerable mechanical stresses in the pump housing.

In order to further improve the emissions behavior of internal combustion engines and to further increase efficiency, it is necessary to provide higher injection pressures than the above-mentioned 1300 bar.

The object of the invention is to modify a radial piston pump so that it can be used for pressures of up to 2000 bar.

1. In a radial piston pump for high-pressure fuel delivery in fuel injection systems of internal combustion engines, preferably with a number of pump elements arranged radially in relation to a drive shaft supported in a pump housing, the pump elements being actuated by the drive shaft and each having a respective inlet side and high-pressure side, and with high-pressure conduits in the pump housing, each of which connects the high-pressure side of a respective pump element to a high-pressure connection in the pump housing, this object is attained according to the invention in that the high-pressure conduits have as few junctions as possible and in that the angle at which one high-pressure conduit branches off from another high-pressure conduit is as close as possible to 90°.

### ADVANTAGES OF THE INVENTION

The routing of the high-pressure conduits in the pump housing in the manner according to the invention makes it possible, in spite of increased pump pressures, to achieve a reduction in the maximal stresses occurring at critical points in the pump housing. As a result, the radial piston pump according to the invention can be operated at higher pressures while at the same time experiencing a reduced strain on the material.

The maximal stresses occurring are determined by means of FEM calculations. In trials with prototypes, the improved compression strength of the pump housing turned out to be due to the routing of the high-pressure conduits in the manner according to the invention.

According to a modification of the invention, the surfaces of the high-pressure conduits are compacted and provided with compressive internal stresses in particular by means of a sphere, whose diameter is slightly greater than the diameter of the high-pressure conduits, being drawn or pressed through the high-pressure conduits. This step further increases the compression strength of the pump housing in the region of the high-pressure conduits.

According to the invention, it is also possible for the high-pressure conduits to be hardened, in particular induction hardened. In order to further minimize the maximal stresses of the pump housing that occur with the exertion of pressure, the high-pressure conduits are rounded, in particular by means of hydrodynamic erosion, in the region of cross sectional changes and/or junctions with other high-pressure conduits.

According to a particularly advantageous embodiment of the radial piston pump according to the invention, the high-pressure conduits are reinforced by a tubular insert, in particular an insert made of a high-strength material; high-tensile steel has turned out to be a particularly suitable material. The tubular inserts according to the invention are, like a core, inserted into the mold before casting. The casting bonds the pump housing and tubular inserts to each other in a very intimate fashion. Because of the tubular inserts, the high-pressure conduits are comprised of a different material, particularly preferably a stronger one, than the rest of the pump housing, and as a result, the component strength is adapted to the local strains and stresses. This assures that, on the one hand, in the region of the high-pressure conduits where the highest stresses occur during operation, a higher-strength material is used, which can reliably withstand the stresses that occur, and on the other hand, the rest of the pump housing can be made of a comparatively inexpensive material that can also be easily machined and has good antifrictional properties.

Another advantage of the tubular inserts according to the invention is that by contrast with conventional bores, the high-pressure conduits can be embodied as curved or partially curved. It is also possible to use a separate insert to connect the high-pressure side of each pump element directly to the high-pressure connection in the pump housing, thus eliminating the need for any junctions in the high-pressure conduits. This has a favorable effect on the maximal stresses occurring in the pump housing, on the manufacturing costs, and in particular on the production safety.

According to another variant of a radial piston pump according to the invention, each pump element has a cylinder bore and a cylinder head, the piston oscillates in the piston bore and feeds a delivery chamber, a first check valve is disposed on the inlet side, and a second check valve is disposed on the high-pressure side. It has turned out to be advantageous if the cylinder bore is embodied as a blind bore and the first check valve is disposed at the bottom of the blind bore. Embodying the cylinder bore as a blind bore eliminates one seal location.

According to another modification of the invention, the second check valve has a sleeve with a stepped center bore, the stepped center bore has a sealing seat for a valve element, in particular a ball, particularly preferably a ceramic ball, and the sleeve of a screw sealing plug is pressed against the cylinder head in a sealed fashion. This second check valve has the advantage that it is very simply designed and can be tested outside the radial piston pump. All that needs to be provided inside the radial piston pump or pump element is a sealing surface that seals the screwed-in second check valve at its end. In production engineering terms, a sealing surface of this kind is easy to control, thus making it easier to seal the high-pressure side of the pump element in relation to the environment at this location through the use of the second check valve according to the invention.

Sealing the high-pressure side in relation to the environment is particularly effective if the sleeve has a biting edge on its end surface oriented toward the screw sealing plug, thus increasing the surface pressure and also permitting a plastic deformation of the sealing surfaces, which further improves the sealing function.

If the sleeve is pressed-fitted onto the screw sealing plug, particularly in the region of the center bore, then this further simplifies the installation of the check valve since it assures that the assembled, tested check valve will not come apart.

In order to assure a constant hydraulic connection between the delivery chamber on the one hand and the high-pressure connection in the pump housing on the other when the second check valve is open, the sleeve has a lateral bore and an annular groove, and the lateral bore and annular groove produce a hydraulic connection between the center bore and the delivery chamber.

In another variant of a first or second check valve, a sealing seat is incorporated into the side of the cylinder head oriented toward the pump housing; the check valve has a cage, which contains a closing spring that acts on the valve member, in particular a ball. The closing spring reduces the return flow of fuel, which has an advantageous effect on the pump efficiency.

The installation of the check valve according to the invention into the pump element is simplified if the cage is press-fitted into a stepped bore encompassing the sealing seat.

In an embodiment that is advantageous from a production engineering standpoint, the cylinder bore is embodied as a blind bore and the first check valve according to one of claims 17 and 18 is disposed at the bottom of the blind bore so that the sealing seat of the first and second check valves can be produced in one setup and the first and second check valves are installed in the same direction.

Other advantages and advantageous embodiments of the invention can be inferred from the following drawings, their description, and the claims.

### DRAWINGS

FIG. 1 a is a front view of a first exemplary embodiment of a radial piston pump according to the invention

FIG. 1b is a longitudinal section through the exemplary embodiment according to FIG. 1a, and

FIG. 1c is a cross section through the exemplary embodiment, along the line A-A

FIG. 2a is a cross section through the first exemplary embodiment, along the line B-B,

FIG. 2b is an embodiment alternative to the one in FIG. 2a,

FIG. 3 is a three-dimensional depiction of another exemplary embodiment of a pump housing according to the invention,

FIG. 4 shows another exemplary embodiment of a cylinder head according to the invention,

FIGS. 5 and 6 are longitudinal sections through other exemplary embodiments of cylinder heads according to the invention,

FIGS. 7a and b show details of the check valve according to the exemplary embodiment in FIG. 6.

### DESCRIPTION OF THE EXEMPLARY EMBODIMENTS

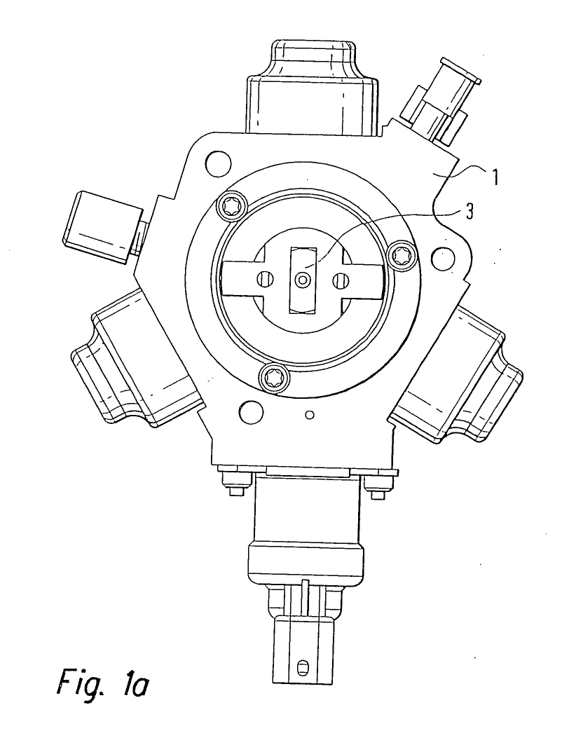

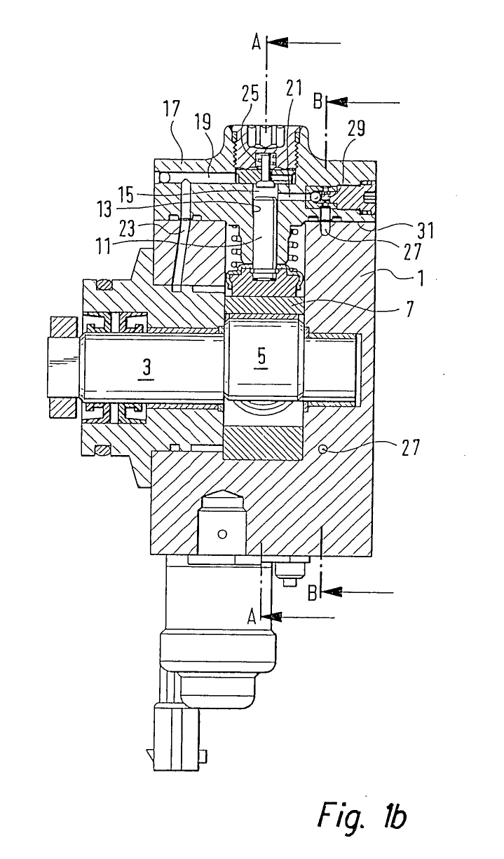

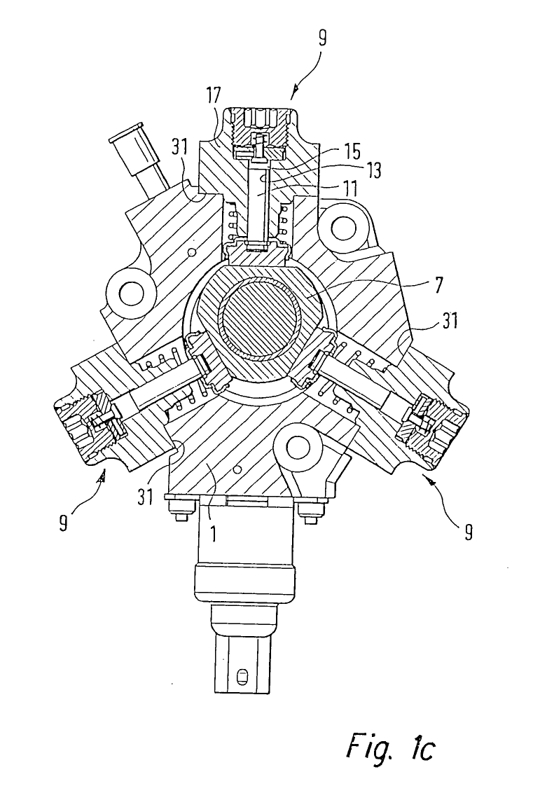

FIG. 1 shows an exemplary embodiment of a radial piston pump according to the invention in a view from the front (FIG. 1a), in a longitudinal section (FIG. 1b), and in a cross section along the section line A-A. The radial piston pump is comprised of a pump housing 1 in which a drive shaft 3 is mounted in rotary fashion. The pump housing 1 can be advantageously made of cast iron with globular graphite (GGG). The drive shaft 3 has an eccentric section 5. By means of a polygon ring 7, the eccentric section 5 drives three pump elements 9 distributed over the circumference. Each pump element 9 has a piston 11 that is guided in a cylinder bore 13 and delimits a delivery chamber 15. Not all of the individual components of all of the pump elements 9 in FIG. 1c are provided with reference numerals in order to avoid unnecessarily compromising clarity. The three pump elements 9, however, are all embodied identically.

A cylinder head 17 of the pump elements 9 contains an inlet side 19 and a high-pressure side 21. The inlet side 19 of the cylinder head 17 is supplied with fuel via a low-pressure bore 23 in the pump housing. On the inlet side 19, a first check valve 25 is provided, which prevents the return flow of fuel (not shown) from the delivery chamber 15 into the low-pressure bore 23.

The high-pressure side 21 of the pump element 9 feeds into a high-pressure conduit 27 in the pump housing 1. On the high-pressure side 21 of the pump element, a second check valve 29 is provided, which prevents the return flow of highly pressurized fuel from the high-pressure conduit 27 into the delivery chamber 15. The pump elements 9 are screw-mounted to the pump housing 1 by means of screws, not shown, and are pressed against a cylinder base surface 31 of the pump housing 1 by this screw connection.

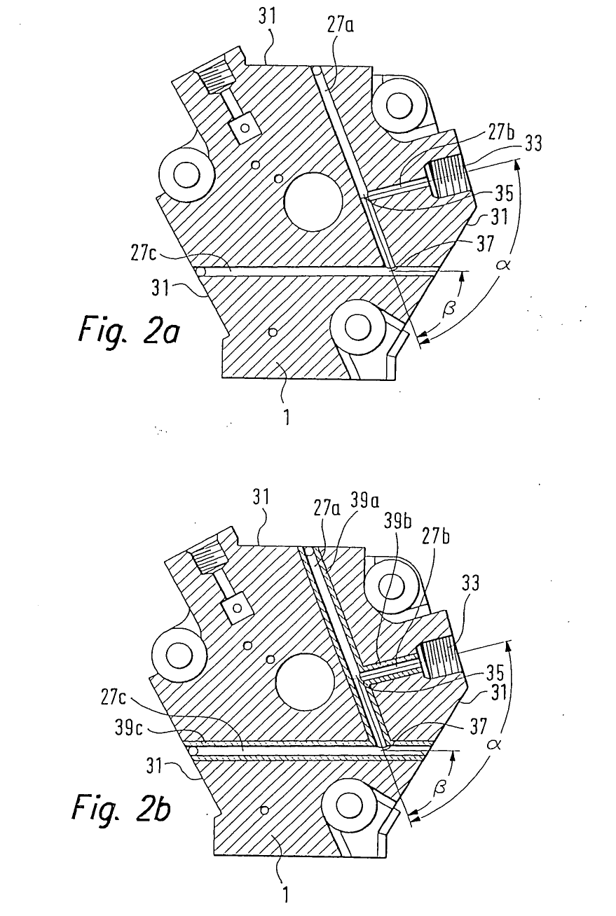

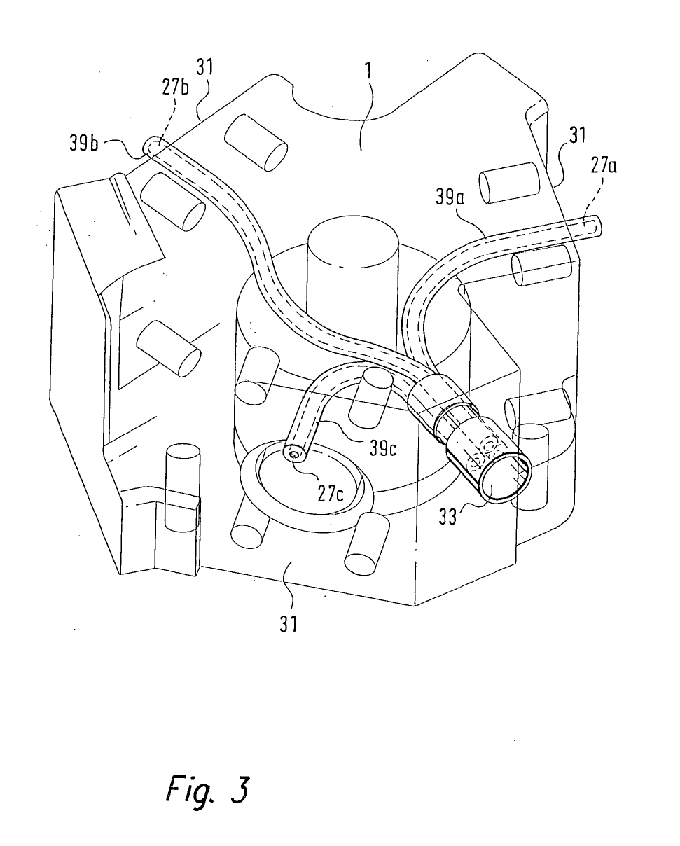

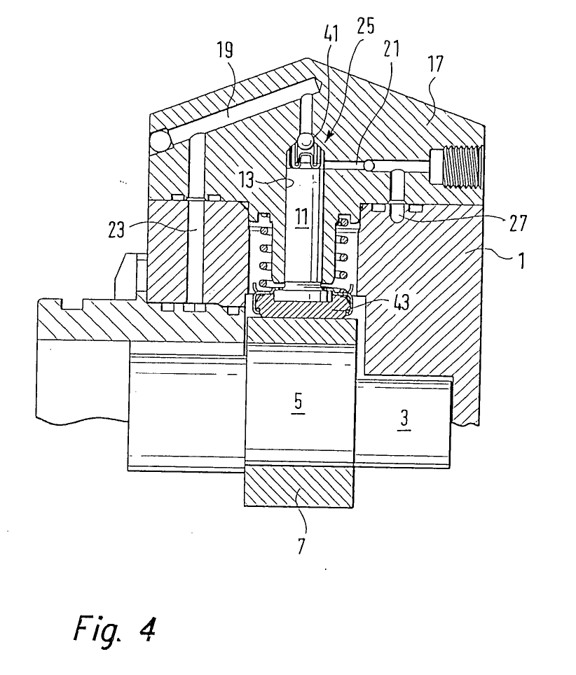

Each pump element 9 has a high-pressure conduit 27 leading from it in the pump housing 1, which feeds into a high-pressure connection not shown in FIGS. 1a to 1c. The course of the high-pressure conduits will be explained below in conjunction with FIGS. 2 and 3. The lower half of a second high-pressure conduit 27 is depicted in FIG. 1b. Since this high-pressure conduit extends essentially perpendicular to the plane of the drawing, it is depicted as a circular area in FIG. 1b.

The above-described design and the function of such a radial piston pump are known from the prior art, for example from DE 197 29 788.9 A1, reference to which is expressly included herein, thus rendering a detailed explanation of the function unnecessary in connection with the current invention.

FIG. 2 shows a cross section through a pump housing 1 along the section line B-B. This depiction clearly shows the course of the high-pressure conduits 27 according to a first exemplary embodiment of the invention.

FIG. 2 shows only the pump housing 1. The pump elements 9 are not shown in FIG. 2. Since the high-pressure conduits 27 in the pump housing 1 are subjected to the full delivery pressure of the pump elements, considerable stresses are produced in the pump housing 1 during the operation of the radial piston pump, which are substantially due to the pressures prevailing in the high-pressure conduits 27a to 27c. Up to this point, mass-produced radial piston pumps with inserted pump elements 9 have been used at operating pressures of up to 1300 bar. If it is now necessary to further increase the operating pressures, then it is necessary to maintain or even improve the fatigue strength of the pump housing, primarily in the region of the high-pressure conduits 27a. Arranging the high-pressure conduits 27a, 27b, and 27c in the manner according to the invention makes it possible, in the presence of the same pressures, to drastically reduce the stresses occurring in the pump housing so that the permissible operating pressures can be increased to over 1800 bar with the same component strength. Even at these operating pressures, which have been increased in comparison to the above-mentioned operating pressures according to the prior art (maximally 1300 bar), the mechanical strain on the pump housing is lower than in the radial piston pumps according to the prior art.

This is achieved according to the invention by minimizing the number of high-pressure conduits. In the current instance, three high-pressure conduits 27a, 27b, 27c suffice to produce a hydraulic connection from the three cylinder base surfaces 31 to a high-pressure connection 33. The high-pressure conduit 27b here branches off from the high-pressure conduit 27a at an angle α of approximately 90°. The angle α should be as close as possible to 90° in order to minimize the stresses occurring at the first junction 35 during operation. The high-pressure conduit 27a intersects the high-pressure conduit 27c at an angle β and forms a second junction 37. The angle β should also be as close as possible to 90°, but this is not always possible, given the structural conditions in the pump housing 1. FEM calculations have demonstrated that arranging the high pressure conduits 27a, 27b, and 27c in the manner according to the invention has resulted in a reduced maximal stress in the pump housing 1 compared to mass produced radial piston pumps, even at significantly higher operating pressures. This has made it possible to increase the permissible operating pressures from 1300 bar to over 1800 bar, without being forced to select a material that is more expensive than the cast iron with globular graphite (GGG) known from the prior art.

A further increase in engineering strength can be achieved by reinforcing the high-pressure conduits 27a with tubular inserts, in particular ones made of a high-strength material. FIG. 2b shows an exemplary embodiment of a pump housing 1 in which the high-pressure conduits 27a to 27c have been reinforced with tubular inserts. The tubular inserts 39 are attached to one another in the region of the first junction 35 and the second junction 37. They are advantageously attached to one another by means of welding or soldering. These tubular inserts 31a to 39c can further increase the strength of the pump housing 1. The tubular inserts 39a to 39c are inserted into the mold before the casting of the pump housing 1. During the subsequent casting of the pump housing, the tubular inserts 39 are intimately bonded to the pump housing 1, thus resulting in an optimal transmission of force between the tubular insert 31 and the pump housing 1.

FIG. 3 is a three-dimensional depiction of another exemplary embodiment of a pump housing according to the invention. It is clear that in this exemplary embodiment, the high-pressure conduits 27a, 27b, and 27c are embodied as curved and each lead directly, i.e. without junctions, from a cylinder base surface 31 to the high-pressure connection 33. In this embodiment, the strains in the pump housing 1 resulting from operating pressures are further reduced due to the lack of junctions. From a production engineering standpoint, this embodiment can be produced by means of curved tubular inserts 39a, 39b, and 39c.

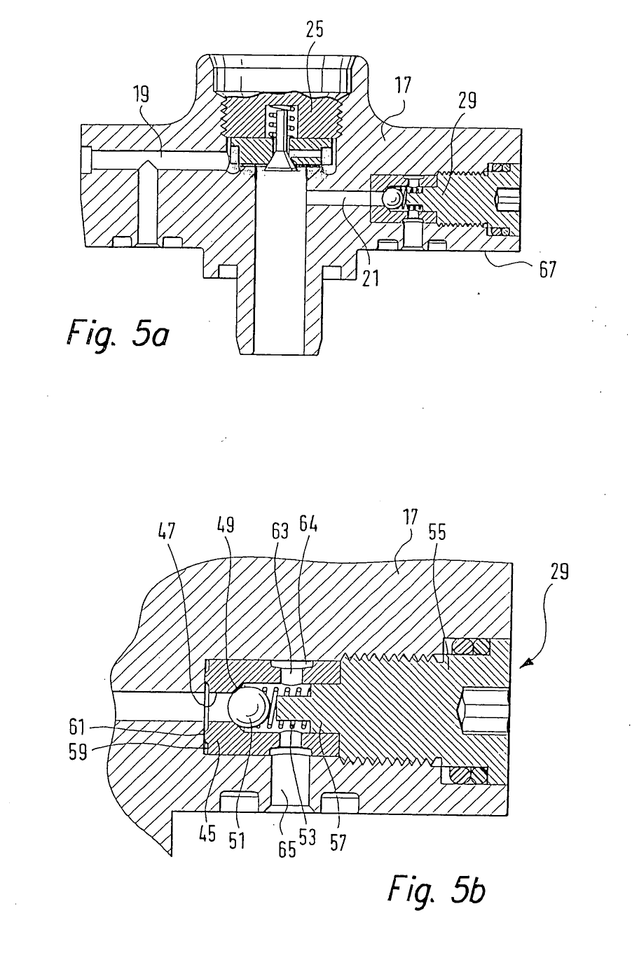

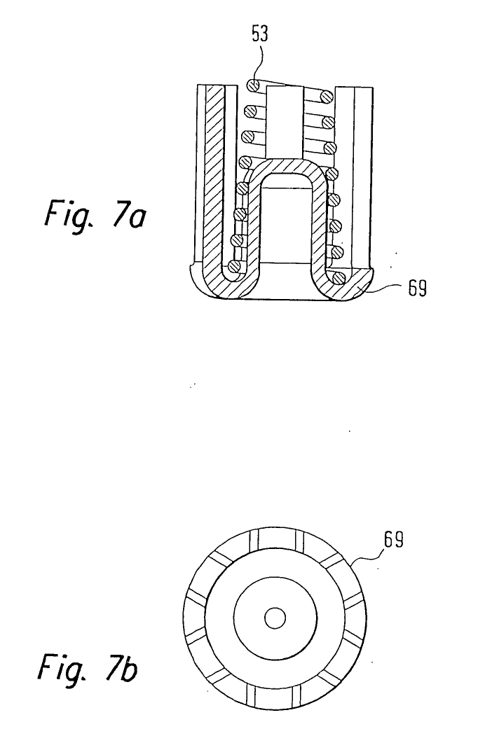

FIG. 4 shows an exemplary embodiment of a radial piston pump according to the invention in which the cylinder bore 13 in the pump element 9 is embodied as a blind bore. At the bottom of the blind bore, a sealing seat 41 is provided for the first check valve 25. The first check valve 25 can be embodied as structurally identical to the second check valve 29 described in conjunction with FIGS. 6 and 7. In the exemplary embodiment according to FIG. 4, the piston 11 is likewise driven by means of a polygon ring and a piston base plate 43. The invention, however, is not limited to radial piston pumps with pump elements 9 driven in this manner. On the contrary, it can also include alternative drive methods such as disk cams or the like. The piston bases can also include tappets (not shown) that are guided in the pump housing 1.

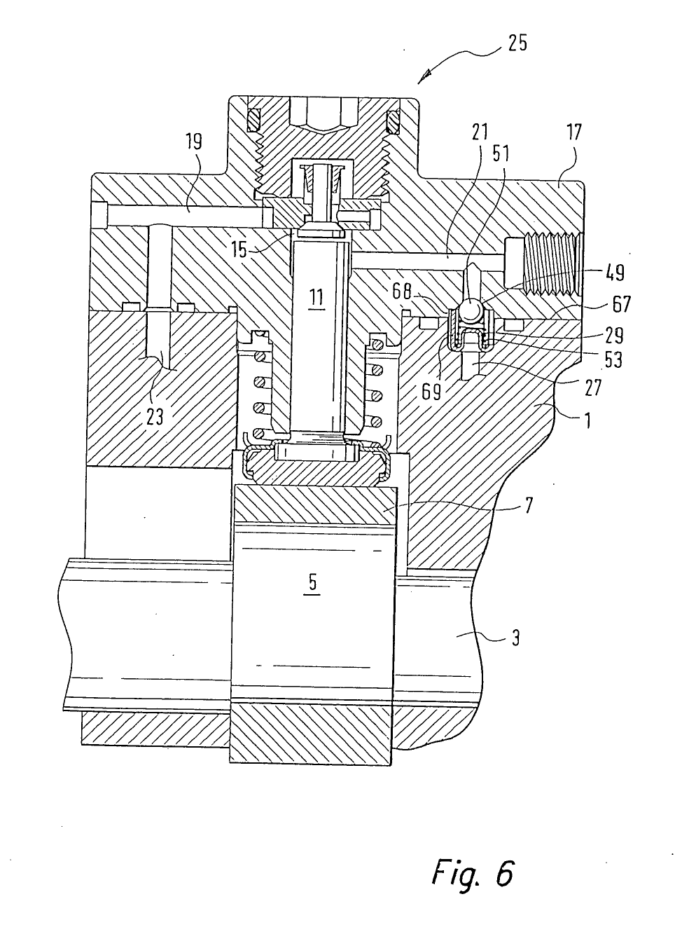

FIG. 5a shows a cross section through a cylinder head 17 of another exemplary embodiment of a radial piston pump according to the invention. The first check valve 25 corresponds to the check valve 25 shown in FIG. 1. The second check valve 29 indicated in FIG. 1b will be illustrated and explained below in conjunction with FIG. 5a and FIG. 5b, which shows an enlarged detail from FIG. 5a.

The second check valve 29 is comprised of a sleeve 45. A sealing seat 49 for a ball 51, in particular a ceramic ball, is let into the stepped bore 47. A closing spring 53, which is supported against a screw sealing plug 55, presses the ball 51 against the sealing seat 49. The use of a closing spring 53 can increase the efficiency of the radial piston pump according to the invention by several percentage points since this prevents a return flow of fuel from the high-pressure conduit 27 not shown in FIG. 5b into the delivery chamber 15, also now shown. The sleeve 45 is press-fitted onto a shoulder 57 of the screw sealing plug 55 so that the second check valve 29 according to the invention can be preassembled with the screw sealing plug 55 and tested ahead of time. On its end surface 59 oriented away from the screw sealing plug 55, the sleeve 45 has a circumferential biting edge 61, which is used to seal the second check valve 29 against the cylinder head 17. A lateral bore 63 and an annular groove 64 in the sleeve 45 permit fuel to flow out into a bore 65 in the cylinder head 17 when the second check valve is open.

FIG. 6 shows another exemplary embodiment of a radial piston pump according to the invention. In this exemplary embodiment, the second check valve 29 is disposed on the side 67 of the cylinder head 17 oriented into the housing 1.

The sealing seat 49 is incorporated into the cylinder head 17. The sealing seat 49 is adjoined by a cylindrical bore 68. The bore 68 has a cage 69 press-fitted into it, which contains a closing spring 53 that presses the ball 51 against the sealing seat 49. This second check valve 29 according to the invention is very easy to manufacture and assemble. It can also be used as a first check valve 25, for example in an embodiment according to FIG. 4. In this instance, it is very advantageous in terms of production that the sealing seat 41 of the first check valve 25 and the sealing seat 49 of the second check valve are disposed parallel to each other, which makes it easier to machine them in one setup of the cylinder head.

FIG. 7a shows a longitudinal section through the cage 69 with the closing spring 53 inserted and FIG. 7b shows a top view of the cage 69 without the closing spring 53.

All features mentioned or depicted in the drawings, their description, and the claims can be essential to the invention both individually and in arbitrary combinations with one another.

1-19. (canceled)

20. In a radial piston pump for high-pressure fuel delivery in fuel injection systems of internal combustion engines, particularly in a common rail injection system, preferably with a number of pump elements (9) arranged radially in relation to a drive shaft (3) supported in a pump housing (1), the pump elements (9) being actuated by the drive shaft (3) and each having a respective inlet side (19) and high-pressure side (21), and with high-pressure conduits (27) in the pump housing (1), each of which connects the high-pressure side (21) of a respective pump element (9) to a high-pressure connection (33) in the pump housing (1), the improvement comprising the high-pressure conduits (27) having as few junctions (35, 37) as possible, and the angle (α, β) at which one high-pressure conduit (27a, 27b, 27c) branches off from another high-pressure conduit (27a, 27b, 27c) being as close as possible to 90°.

21. The radial piston pump according to claim 20, wherein the surfaces of the high pressure conduits (27a, 27b, 27c) are compacted.

22. The radial piston pump according to claim 21, wherein the a sphere whose diameter is slightly larger than the diameter of the high pressure conduits (27a, 27b, 27c) is drawn or pressed through the high pressure conduits (27a, 27b, 27c) to compact the surfaces.

23. The radial piston pump according to claim 21, wherein the high pressure conduits (27a, 27b, 27c) are hardened, in particular are induction hardened.

24. The radial piston pump according to claim 20, wherein the high pressure conduits (27a, 27b, 27c) are rounded, in particular by means of hydrodynamic erosion, in the region of cross sectional changes and/or junctions (35, 37) with other high pressure conduits (27a, 27b, 27c).

25. The radial piston pump according to claim 20, wherein each of the high pressure conduits (27a, b, c) is reinforced by a tubular insert (39a, b, c).

26. The radial piston pump according to claim 25, wherein the inserts (39a, b, c) are comprised of a high-strength material, in particular a high-tensile steel.

27. The radial piston pump according to claim 25, wherein the inserts (39a, b, c) are attached to one another at the junction or junctions (35, 37), in particular by means of soldering or welding.

28. The radial piston pump according to claim 26, wherein the inserts (39a, b, c) are attached to one another at the junction or junctions (35, 37), in particular by means of soldering or welding.

29. The radial piston pump according to claim 20, wherein each of the high pressure conduits (27a, b, c) connects the high-pressure side (21) of a pump element (9) directly to the high-pressure connection (33).

30. The radial piston pump according to claim 20, wherein at least one high-pressure conduit (27a, b, c) is embodied as partially curved.

31. The radial piston pump according to claim 20, wherein each pump element (9) has a piston (11), a cylinder bore (13), and a cylinder head (17), wherein the piston (11) oscillates in the cylinder bore (13) and delimits a delivery chamber (15), wherein a first check valve (25) is disposed on the inlet side (19), and wherein a second check valve (29) is disposed on the high-pressure side (21).

32. The radial piston pump according to claim 31, wherein the second check valve (29) has a sleeve (45) with a stepped center bore (47), wherein the stepped center bore (47) has a sealing seat (49) for a valve element, in particular a ball (51), and wherein the sleeve (45) is pressed against the cylinder head (17) in a sealed fashion by a screw sealing plug (55).

33. The radial piston pump according to claim 32, wherein the end surface (59) of the sleeve (45) oriented away from the screw sealing plug (55) is embodied as a sealing surface, in particular with a biting edge (61).

34. The radial piston pump according to claim 32, wherein the sleeve (45) is press-fitted onto the screw sealing plug (55), particularly in the region of the center bore (47).

35. The radial piston pump according to claim 32, wherein the sleeve (45) has a lateral bore (61) and an annular groove (63), and wherein the lateral bore (61) and the annular groove (63) hydraulically connect the center bore (47) to the delivery chamber (15).

36. The radial piston pump according to claim 31, wherein a sealing seat (49) of the second check valve (29) is disposed on the side (67) of the cylinder head (17) oriented toward the pump housing (1).

37. The radial piston pump according to claim 20, wherein the first and/or second check valve (25, 29) has a cage (69), and that the cage (69) contains a closing spring (53) that acts on the valve element (51).

38. The radial piston pump according to claim 37, wherein the cage (59) can be press-fitted into a stepped bore (65) that is embodied in the cylinder head (17) and encompasses the sealing seat (49).

39. The radial piston pump according to claim 20, wherein the cylinder bore (13) is embodied as a blind bore and that the first check valve (25) is disposed at the bottom of the blind bore.
